(19) United States
(12) Patent Application Publication
(10) Pub. No.: US 2005/0032018 A1
(43) Pub. Date: Feb. 10, 2005

(54) Adjustable dental impression tray

(76) Inventor: Dennis J. White, Plainsboro, NJ (US)

Correspondence Address: DENNIS J. WHITE, 17 NOSTRAND ROAD, CRANBURY, NJ, 08512, US

(21) Appl. No.: 10/632,984

(22) Filed: Aug. 4, 2003

(51) Int. Cl. A61C 9/00

(52) U.S. Cl. 433/41

(57) ABSTRACT

This invention discloses a new dental impression tray that is adjustable without a clamping means. The single sized tray serves for all the different arch size configurations. Most tray fitting problems arise in adaptation in the posterior segment. This tray is simply spread apart to adapt to size of arch and used directly with no clamping or fixation. The newly adjusted tray's shape is maintained by only the integrity of the outer wall.

### FIELD OF INVENTION

This invention relates to dental impression trays. Dental impression trays are used to support impression material which is utilized by dental care providers to capture an imprint of the dental form.

### DESCRIPTION OF THE PRIOR ART

Dental impression trays are used to bring curable impression compounds into the oral cavity. Also, when timing dictates, this tray serves to remove this set material from the mouth. It also serves to support the resultant impression mold while mixed stone or other hardening materials are utilized. This formed cast of the mouth may then be used for study.

The many different sizes and shapes of the dental arch necessitate many different sizes of trays.

This application discloses a tray that can be adjusted in the posterior segment. This adjustment can allow for wider mouths. It can therefore accommodate many arch configuaraions and reduce the number of trays needed for inventory.

In U.S. Pat. No. 1,499,482, Simmons reveals a tray that can be adjusted and then held by a clamping screw. A necessary step is needed for stabilizing adjusted tray.

In U.S. Pat. No. 6,428,315, Prestipino et al. describe a tray that can be adjusted for length by breaking segments. It can't adjust for different arch widths.

In U.S. Pat. No. 4,368,040, Weissman has shown a tray that can be adjusted to arch width and can be held in place, by clamping means.

In U.S. Pat. No. 4,145,812, Johnson et al. also shows tray with telescopic length that can be adjusted to the arch length. This tray is not adjustable to width.

In U.S. Pat. No. 6,196,840, Zentz et al. show a tray and occlusion rim which is adjustable to the arch by shaping after heating.

In U.S. Pat. No. 5,340,308 Cukjati shows a tray with sliding portions to adjust to different situations. Adjustments are set with locking screws.

### Objects and Advantages

Posterior segments of the dental arch often flare toward the buccal especially on the maxilla. This posterior spreading of the upper arch requires wider trays.

Dentists have many different size and style trays to accommodate different impression challenges. The most significant challenge is meeting the demand for sizing of the dental tray to the different size arches.

The goal of this disclosure is to reduce the large inventory of trays, save time, and yield more accurate models. One tray will fit many size maxillary and mandibular arches.

The disclosed tray is readily adjusted. This refinement is made without clamping or screwing.

Use of this invented tray reduces a large inventory of trays since it is adjustable to fit most applications.

It is also important to note that most different size trays commercially now available are proportionately larger throughout the entire tray. It clinical use the variable between different arch forms is in the posterior area and not significantly so in the canine to canine anterior areas. This disclosed tray opens wider in these posterior areas.

This new tray saves time. Heretofore, different shape trays are repeatedly tried for fit. This trial and error method for the professional to find the correct tray would is thus eliminated.

The fine tuned fit of an adjustable tray has potential for better results over a stock tray. Dentists seek to get one quarter inch clearance between the outside of the arch and the dental tray. This can be more readily achieved in an adjustable tray.

In present art, distortion does happen occasionally at time of tray removal from mouth. This new disclosure aids because it allows for greater movement within the tray when removal forces are applied.

### BRIEF DESCRIPTION OF DRAWING

FIG. 1 is a top perspective view of impression tray of the present invention.

FIG. 2 is a lateral view of this new adjustable impression tray.

FIG. 3 is a top perspective view of adjusted tray over teeth.

### DETAILED DESCRIPTION OF THE PREFERRED EMBODIMENT

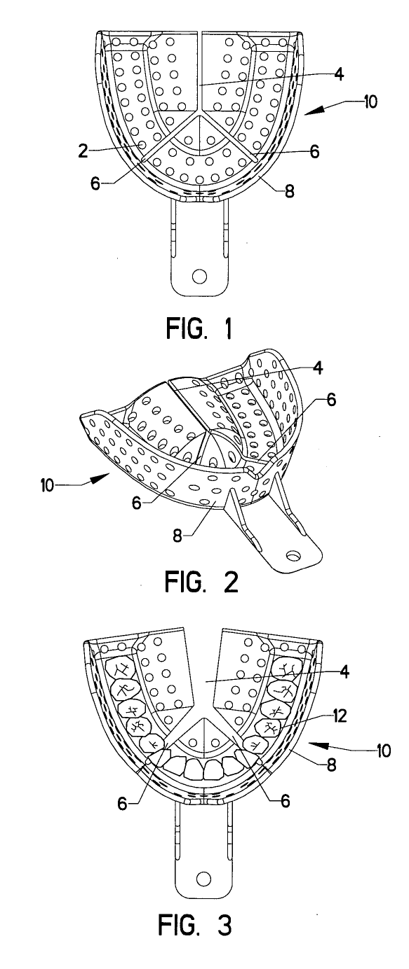

FIG. 1 shows the maxillary impression tray, 10. The shape overall of the outer wall, 8 is generally horseshoe shaped. There is a longitudinal break, 4, in the palatal aspect or inner wall of tray. There are also oblique breaks, 6, in the anterior palatal portion or connecting base of adjustable tray. The tray has a vertical wall, 8 about the outside periphery. The breaks, 4 and 6 in the tray, 10 do not continue through the vertical wall, 8. This outer vertical wall, 8 supports the segmented areas of the tray, 10. Overall the tray is U shaped to cup over the teeth. Holes, 2 enhance adhesion of impression material to tray, 10.

In use, the adjustable dental tray, 10, is tried in mouth over teeth, 12, to evaluate the fit of tray, FIG. 3. The tray, 10 is removed from the mouth. It is then simply sprung open manually to assume a wider posterior dimension. The fit of tray, 10, FIG. 3, is verified in the mouth over the teeth, 12. It may again be readjusted. The final tray adjustment is finalized when an even one quarter inch space exists between the teeth, 12 and tray, 10. The tray, 10, may also be used directly, with no adjustments, if this condition for one quarter inch clearance is met.

### CONCLUSION, RAMIFICATIONS AND SCOPE OF INVENTION

In most cases, the anterior portion of dental impression trays will fit well, but the posterior portion of present trays will bind on the buccal aspects of the posterior teeth. That is, the trays, as a generality, are usually too narrow in the posterior areas. The advantage of this tray is versatility. The tray is easily adjusted. And once adjusted there is no additional step to stabilize. Since no clamping means is necessary, production costs are reduced.

This new design of an adjustable tray is certainly not obvious. Without a tray adjustment stabilizer practitioners would be skeptical. Many would feel that the final model accuracy would be compromised. They may also feel that the impression material will fall right through the open slot of the tray. These opinions are logical but not a deterrent. In practice the model accuracy is in actuality increased. This can be confirmed by the dentist in regular daily use and can also be confirmed by use of a model checker, U.S. Pat. No. 5,924,862.

The inventor recognizes that the holes as seen in drawings may not always be necessary. There are also commercially available attachment media. These include adhesives and tray designed undercuts. One manufacture even makes an adhesive felt button for retention of impression material. Trays are also used without vertical walls. They utilize a beaded plastic in place of walls. Many triple trays share this design. This disclosure could also utilize a beaded design tray.

3. A dental impression tray, comprising:
an outer wall of deformable, non-memoric material of sufficient length to accommodate length of the average dental arch;
an inner wall arranged generally parallel with outer wall;
said inner wall comprising at least one break;
said inner and outer walls arranged generally horseshoe shaped;
a connecting member between said walls;
said connecting member comprising at least one break;
wherein sizing of tray is provided by deformation of outer wall.

4. The dental impression tray defined in claim 1 is made of plastic.

5. A dental impression tray, comprising:
an outer wall of deformable, non-memoric material of sufficient length to accommodate length of the average dentition;
an inner wall arranged generally parallel with outer wall;
said inner wall comprising at least one break;
said inner and outer walls arranged generally horseshoe shaped;
a connecting member between said walls;
said connecting member comprising at least one break, whereby a single molded piece transformably accommodates different size dental arches.

6. The adjustable impression tray as defined in claim 5, wherein said inner and outer walls are sufficiently short to accommodate dual arch impression technique.

7. The adjustable impression tray as defined in claim 5, wherein said connecting member is sufficiently thin to accommodate dual arch impression technique.
